(19) United States
(12) Patent Application Publication
(10) Pub. No.: US 2006/0216558 A1
(43) Pub. Date: Sep. 28, 2006

(54) Monitor connection of fuel cell stack

(75) Inventors: Atsushi Miyazawa, Yokohama-shi (JP); Hiroshi Miyakubo, Yokosuka-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/387,877

(22) Filed: Mar. 24, 2006

(30) Foreign Application Priority Data
Mar. 25, 2005 (JP) 2005-088095

(51) Int. Cl. H01M 8/04; H01M 8/10; H01M 8/02

(52) U.S. Cl. 429/23; 429/32; 429/34

(57) ABSTRACT

A fuel cell stack is constructed by laminating together unit fuel cells (1) each comprising an anode separator (7) and a cathode separator (8) sandwiching an MEA (13). The cathode separator (8) comprises on the outer circumference thereof outward projections (28) and (29) to which two terminals (91) of a voltage monitor (92) that monitors the voltage of a specific unit fuel cell (1) are connected. One of the terminals (91) is connected to the outward projection (28) of one cathode separator (8), while the other terminal (91) is connected to the outward projection (29) of another cathode separator (8). The outward projections (28) and (29) to which the terminals are connected do not overlap in the lamination direction of the unit fuel cells (1), and therefore an environment in which short-circuits are unlikely to occur between the terminals due to vibration or shock is obtained.

### FIELD OF THE INVENTION

This invention relates to the connection of a monitor, which detects a power generation state of a specific unit fuel cell in a fuel. cell stack, to a separator which separates the specific unit fuel cell from other fuel cells.

### BACKGROUND OF THE INVENTION

A fuel cell functions to convert the chemical energy of a fuel directly into electric energy, and comprises an anode and a cathode provided on either side of an electrolyte membrane. The anode is supplied with a fuel gas containing hydrogen, while the cathode is supplied with an oxidant gas containing oxygen. As a result, the following electrochemical reaction occurs at the anode and cathode, producing electric energy.
Anode: H₂→2H⁺+2e (1)
Cathode: 2H⁺+2e⁻+(½)O₂→H₂O (2)

Hydrogen gas from a hydrogen storage device is supplied to the anode directly as the fuel gas. Alternatively, a gas containing hydrogen that is generated by reforming a fuel such as gasoline, alcohol, or natural gas is supplied as the fuel gas. The hydrogen storage device may be a high-pressure gas tank, a liquid hydrogen tank, a metal hydride tank, or similar.

Air is typically used as the oxidant gas that is supplied to the cathode.

Fuel cells are typically used in the form of a fuel cell stack, which is formed by laminating fuel cells on either side of plates known as separators. In the following description, a single fuel cell will be referred to as a unit fuel cell. A carbon separator obtained by pressing a composite material having graphite or resin and graphite powder as main components is used as the separator, for example.

Thin carbon separators and metallic separators that can easily be reduced in thickness are currently in development, particularly for fuel cells to be installed in a moving body, with the aim of reducing the size and improving the power density of the fuel cell.

The thickness of a typical thin carbon separator is no more than 2 mm, while the thickness of a typical metallic separator is between 0.05 and 0.5 mm.

### SUMMARY OF THE INVENTION

JP2004-079192A, published by the Japan Patent Office in 2004, teaches the use of a voltage monitor connected to adjacent unit fuel cells to detect the voltage of the unit fuel cells.

However, when this prior art is applied to a unit fuel cell using a thin separator such as that described above, a voltage terminal attached to the separator of the unit fuel cell may contact the voltage terminal attached to the separator of the adjacent unit fuel cell due to vibration or. the like, causing a short-circuit.

It is therefore an object of this invention to prevent short-circuits from occurring when a detector for detecting the power generation state of a unit fuel cell is connected to a fuel cell stack having a small lamination pitch.

In order to achieve the above object, this invention provides a fuel cell stack comprising membrane electrode assemblies and separators alternately laminated in a lamination direction, and a monitor which collects data representing a power generation state of a membrane electrode assembly located between two specific separators. The monitor has two terminals which are connected respectively to the two specific separators.

Each of the two specific separators comprises an outward projection on an outer circumference thereof. The outward projections of the two specific separators are arranged so as not to overlap with each other in the lamination direction, and the terminals are connected to the outward projections of the two specific separators.

This invention also provides a fuel cell stack in which membrane electrode assemblies, each having an electrolyte membrane, and separators sandwiching the membrane electrode assemblies, are laminated alternately. The fuel cell stack comprises a monitor which collects data representing a power generation state of a membrane electrode assembly located between two specific separators. The monitor has two terminals which are connected respectively to the two specific separators. The separator is formed in point symmetry about a diagrammatic center, the separator comprises an outward projection on an outer circumference thereof, and the two specific separators are laminated after being rotated 180 degrees about the diagrammatic center.

The details as well as other features and advantages of this invention are set forth in the remainder of the specification and are shown in the accompanying drawings.

### BRIEF DESCRIPTION OF THE DRAWINGS

FIG. 1 is a schematic horizontal sectional view of a unit fuel cell according to this invention.

FIG. 2 is a schematic plan view of an anode separator according to this invention.

FIG. 3 is a schematic plan view of a cathode separator according to this invention.

FIG. 4 is a schematic perspective view of a unit fuel cell, illustrating the connection state of a voltage monitor to adjacent cathode separators.

FIG. 5 is a schematic horizontal sectional view of the main parts of a fuel cell stack and a connector, according to this invention.

FIG. 6 is a schematic cross-sectional view of the connector, taken along a line VI-VI in FIG. 5.

FIG. 7 is a schematic cross-sectional view of the main parts of the fuel cell stack, taken along a line VII-VII in FIG. 5.

FIG. 8 is a schematic plan view of the cathode separator, illustrating variation in the arrangement of outward projections.

FIG. 9 is a schematic plan view of a separator according to a second embodiment of this invention.

FIG. 10 is a schematic perspective view of the main parts of a fuel cell stack according to the second embodiment of this invention.

FIG. 11 is a schematic plan view of an anode separator according to a third embodiment of this invention.

FIG. 12 is a schematic perspective view of the main parts of a fuel cell stack according to the third embodiment of this invention.

FIG. 13 is a schematic plan view of a membrane electrode assembly according to a fourth embodiment of this invention.

FIG. 14 is a cross-sectional view of the membrane electrode assembly according to the fourth embodiment of this invention, taken along a line XIV-XIV in FIG. 13.

FIG. 15 is an exploded horizontal sectional view of a fuel cell stack according to the fourth embodiment of this invention.

FIG. 16 is a schematic cross-sectional view of a connector according to the fourth embodiment of this invention.

### DESCRIPTION OF THE PREFERRED EMBODIMENTS

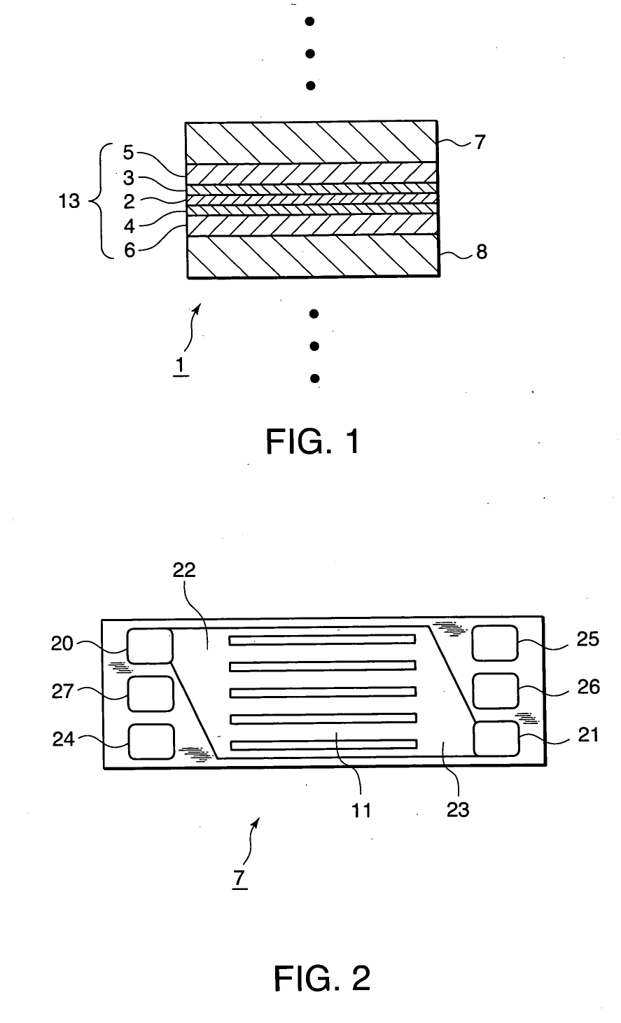

Referring to FIG. 1 of the drawings, a unit fuel cell 1 comprises a membrane electrode assembly (MEA) 13 constituted by a proton-conducting polymer electrolyte membrane 2, an anode catalyst layer 3 and a cathode catalyst layer 4 sandwiching the electrolyte membrane 2, an anode gas diffusion layer 5 laminated onto the outside of the anode catalyst layer 3, and a cathode gas diffusion layer 6 laminated onto the outside of the cathode catalyst layer 4.

The unit fuel cell 1 further comprises an anode separator 7 provided on the outside of the anode gas diffusion layer 5 and having a hydrogen passage 11 to be described below, and a cathode separator 8 provided on the outside of the cathode gas diffusion layer 6 and having an air passage 12 to be described below. The unit fuel cell 1 further comprises a cooling water passage, not shown in the drawing, for cooling the unit fuel cell 1. Edge seals are provided between the MEA 13 and the anode separator 7 and cathode separator 8, or between adjacent separators 7 and 8, to prevent hydrogen, air, and cooling water leakage.

A fuel cell stack is constructed by laminating together approximately one hundred unit fuel cells 1 and electrically connecting them in series. This invention is applied to a fuel cell stack constituted in this manner.

The anode separator 7 and cathode separator 8 are formed by pressing or punching a metal plate which is formed by implementing metal plating on a stainless steel plate prescribed by JIS SUS316, serving as a substrate. Alternatively, the anode separator 7 and cathode separator 8 may be formed by etching SUS316. A stainless steel material other than SUS316, copper, aluminum, titanium, or another metallic material may be used as the substrate. These metallic materials may be further subjected to corrosion-resistant surface treatment such as plating. Furthermore, the separators 7, 8 are not limited to metallic materials, and may be constituted by carbon separators formed using graphite or the like, for example.

Referring to FIG. 2, the anode separator 7 will be described. FIG. 2 is a front view of the anode separator 7 of the unit fuel cell 1, seen from the MEA 13 side.

The anode separator 7 comprises a hydrogen passage 11 for transporting hydrogen, which faces the anode gas diffusion layer 5 of the MEA 13. Hydrogen is supplied to the hydrogen passage 11 of each anode separator 7 from an external hydrogen cylinder, for example, through a hydrogen introduction manifold 20 which penetrates the fuel cell stack. The hydrogen passage 11 is constituted by a plurality of parallel, linear channels formed in the anode separator 7. The hydrogen in the hydrogen passage 11 penetrates into the anode catalyst layer 3 through the anode gas diffusion layer 5, and initiates the electrochemical reaction of the above equation (1) in the anode catalyst layer 3. The remaining hydrogen in the hydrogen passage 11 flows out into a hydrogen discharge manifold 21 which penetrates the fuel cell stack on the opposite side to the hydrogen introduction manifold 20, and is discharged to the outside of the fuel cell stack through the hydrogen discharge manifold 21.

The hydrogen passage 11 is connected to the hydrogen introduction manifold 20 via a diffuser 22. The hydrogen passage 11 is connected to the hydrogen discharge manifold 21 via a diffuser 23. An air introduction manifold 24, a cooling water discharge manifold 27, and the hydrogen introduction manifold 20, all of which penetrate the fuel cell stack, are formed side by side in the anode separator 7. An air discharge manifold 25, a cooling water introduction manifold 26, and the hydrogen discharge manifold 21, all of which penetrate the fuel cell stack, are formed side by side in a similar manner.

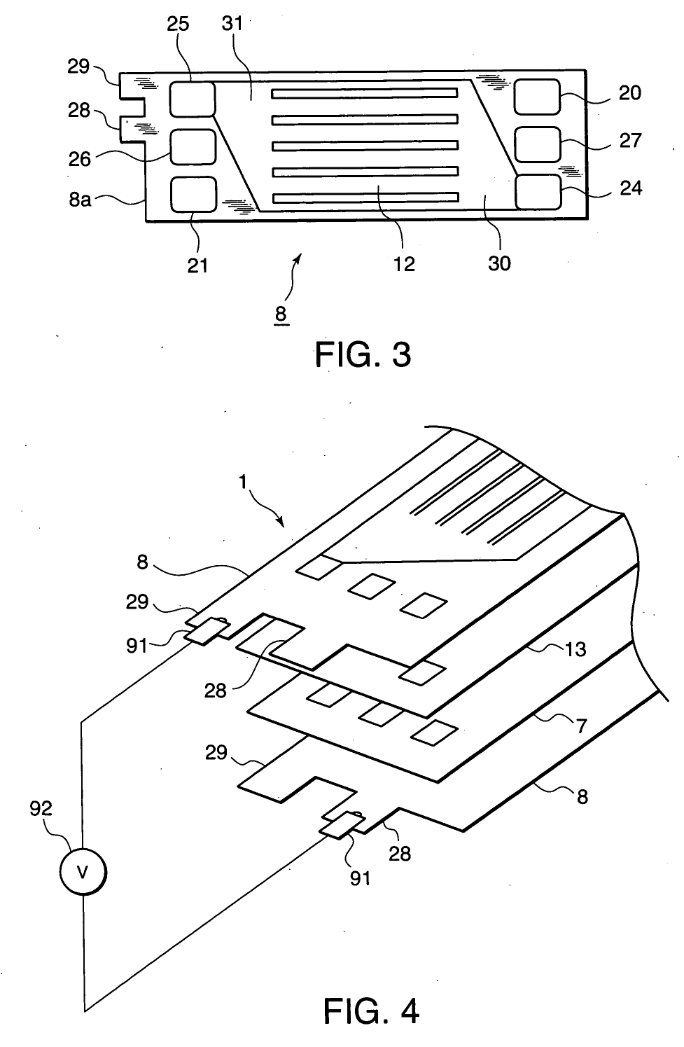

Referring to FIG. 3, the cathode separator 8 will be described. FIG. 3 is a front view of the cathode separator 8 of the unit fuel cell 1, seen from the MEA 13 side.

The cathode separator 8 comprises an air passage 12 for transporting air, which faces the cathode gas diffusion layer 6 of the MEA 13. Air introduced from the outside is supplied to the air passage 12 of each cathode separator 8 through the air introduction manifold 24. The air passage 12 is constituted by a plurality of parallel, linear channels formed in the cathode separator 8. The oxygen contained in the air in the air passage 12 penetrates into the cathode catalyst layer 4 through the cathode gas diffusion layer 6, and initiates the electrochemical reaction of the above equation (2) in the cathode catalyst layer 4. The remaining air in the air passage 12 and water vapor generated in the cathode catalyst layer 4 flow out into the air discharge manifold 25 and are discharged to the outside of the fuel cell stack through the air discharge manifold 25.

The air passage 12 is connected to the air introduction manifold 24 via a diffuser 30. The air passage 12 is connected to the air discharge manifold 25 via a diffuser 31.

The channels constituting the hydrogen passage 11 and the channels constituting the air passage 12 are parallel and have the same flow direction. However, the hydrogen passage 11 and air passage 12 may be provided in a serpentine form constituted by linear portions and loop-back portions, instead of a linear form.

A short side 8a of the rectangular cathode separator 8, corresponding to a side face of the fuel cell stack, comprises outward projections 28 and 29 for connecting terminals 91 of a voltage monitor 92 shown in FIG. 4, which detects a generated voltage of the unit fuel cell 11 during an operation. The outward projections 28 and 29 protrude sideways from the short side 8a. A predetermined interval is provided between the outward projection 28 and the outward projection 29. The outward projection length of the outward projections 28 and 29 is set between one and ten millimeters.

When the cathode separator 8 is constituted by a metallic material, the thickness of the cathode separator 8 can be reduced, but when the cathode separators 8 are laminated in a fuel cell stack, the outward projection 28 or the outward projection 29 may come into contact with the outward projection 28 or the outward projection 29 of the adjacent unit fuel cell 1 due to vibration or the like, causing a short-circuit. Therefore, the outward projection length of the outward projections 28 and 29 is determined on condition that the terminals of the voltage monitor do not become disengaged, and that no short-circuits are caused by contact between adjacent outward projections 28 (29) due to vibration or the like. A corrugated portion or the like, for example, is preferably provided on the outward projections 28 and 29 to reduce the likelihood of the voltage monitor terminals becoming disengaged.

Referring to FIG. 4, one of the two terminals 91 of the voltage monitor 92 is connected to the outward projection 28 on the cathode separator 8 of the unit fuel cell 1, while the other terminal 91 is connected to the outward projection 29 on the cathode separator 8 of the adjacent unit fuel cell 1.

In a fuel cell power plant for a vehicle, for example, the power plant is constituted using a fuel cell stack in which the voltage monitor 92 is connected to the outward projections 28 and 29 on any adjacent unit fuel cells 1 in advance in the manner described above. In other words, the voltage monitor 92 forms a part of an in-service fuel cell stack.

The outward projections 28 are disposed so as to overlap in the lamination direction, and the outward projections 29 are also disposed so as to overlap in the lamination direction. By connecting one of the terminals 91 of the voltage monitor 92 to the outward projection 28 on the unit fuel cell 1 and connecting the other terminal 91 of the voltage monitor 92 to the outward projection 29 on the adjacent unit fuel cell 1 in this manner, short-circuits between the terminals 91 of the voltage monitor 92 can be prevented.

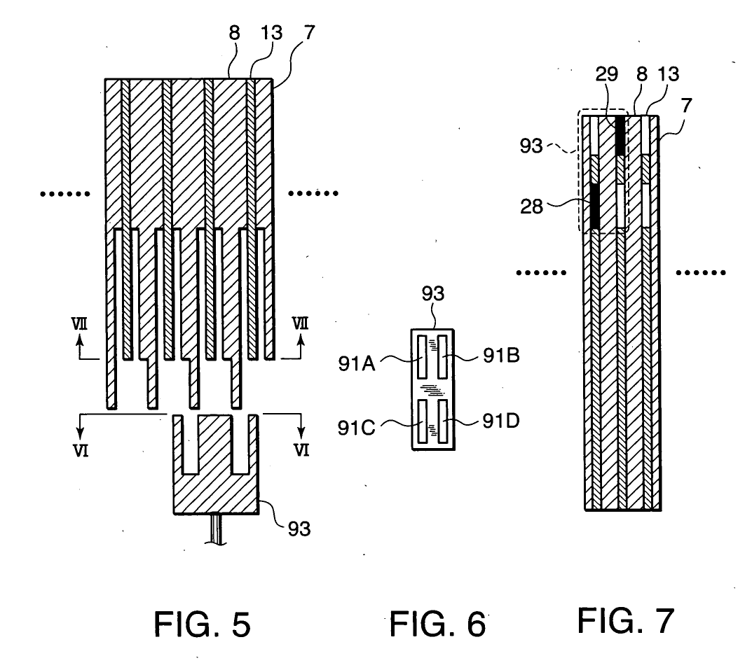

More specifically, referring to FIGS. 5 and 6, the pair of terminals 91 is formed on the inside of a single bayonet connector 93. The connector 93 is formed with a total of four insertion holes 91A-91D into which two adjacent outward projections 28 and two adjacent outward projections 29 are inserted. The outward projections 29 and 28 inserted into one diagonal group of insertion holes 91A and 91D, from among the four insertion holes 91A-91D, are electrically connected to the voltage monitor 92, while the outward projections 29 and 28 inserted into the other diagonal group of holes 91B and 91C are each electrically insulated. In other words, the insertion holes 91A and 91D constitute the terminals 91.

Referring to FIG. 7, when the connector 93 is attached to the fuel cell stack, the outward projections 28 and 29 shown in the drawing communicate, while the other group of outward projections 28 and 29 are insulated. Even when the vehicle vibrates, adjacent outward projections 28 or adjacent outward projections 29 do not come into contact with each other in this part. Hence, the generated voltage of the unit fuel cell 1 can be detected by the voltage monitor 92 with a high degree of precision. In order to secure electrical contact between the insertion holes 91A and 91D and the outward projections 29 and 28 even during vibration or impact, the outward projections 29 and 28 are preferably adhered to the insertion holes 91A and 91D during assembly of the fuel cell stack using a conductive adhesive.

It should be noted that short-circuits between adjacent outward projections 28 or adjacent outward projections 29 can be prevented reliably in all sites of the fuel cell stack by cutting off the outward projections 28 and 29 that are not connected to the terminals 91 in locations other than the attachment location of the connector 93, or by covering these outward projections 28 and 29 with an insulating member.

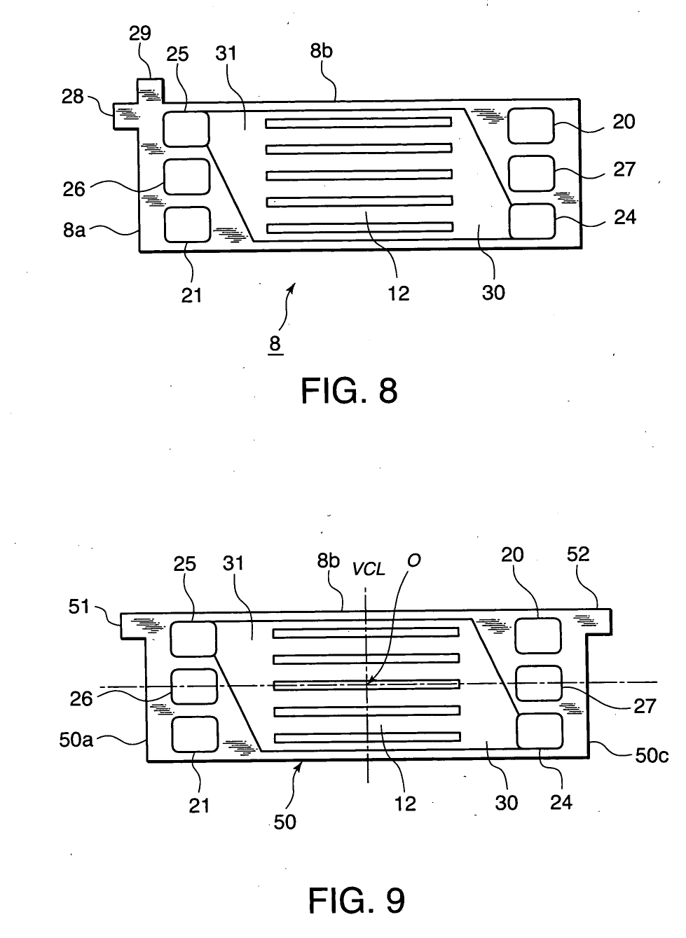

In this embodiment, the outward projections 28 and 29 are formed in series on one side of the cathode separator 8. However, the formation site of the outward projections 28 and 29 may be set as desired, and as shown in FIG. 8, for example, one outward projection 28 may be formed on the short side 8a, while the other outward projection 29 is formed on a long side 8b forming a right angle with the side 8a. Furthermore, the number of outward projections 28, 29 formed on the cathode separator 8 is not limited to two, and three or more outward projections may be formed. Moreover, the outward projections 28 and 29 may be formed on the anode separator 7 instead of the cathode separator 8.

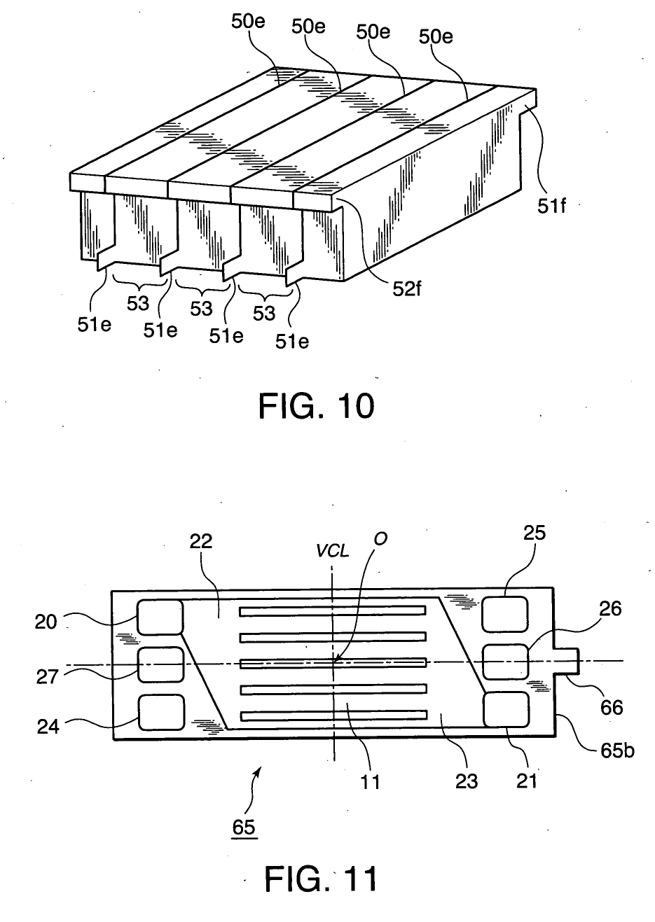

Next, referring to FIGS. 9 and 10, a second embodiment of this invention will be described.

In a fuel cell stack according to this embodiment, each unit fuel cell differs from the first embodiment in that a single separator 50 is used as an anode separator and a cathode separator.

Referring to FIG. 9, the separator 50 comprises an outward projection 51 on one short side 50a, and an outward projection 52 on an opposing short side 50c. The drawing shows a case in which the separator 50 is used as a cathode separator.

In the separator 50, the hydrogen introduction manifold 20, cooling water discharge manifold 27, air introduction manifold 24, air discharge manifold 25, cooling water introduction manifold 26, and hydrogen discharge manifold 21 are formed in the same positions as the manifolds formed in the cathode separator 8 of the first embodiment shown in FIG. 3. The air passage 12 is also formed similarly to that of the cathode separator 8 such that one end thereof is connected to the air introduction manifold 24 via the diffuser 30, and the other end thereof is connected to the air discharge manifold 25 via the diffuser 31.

As for the anode separator, the separator 50 is used in a state where the separator 50 is rotated 180 degrees about the vertical center line VCL in FIG. 9.

In this embodiment, the positional relationship between the outward projection 51 and the outward projection 52 is set in the following manner.

Measures are taken to ensure that the outward projections 51 and 52 are not disposed in opposing positions about a center O of the separator 50. More specifically, measures are taken to ensure that when the separator 50 is rotated 180 degrees about the center O, the post-rotation outward projection 51 does not overlap the pre-rotation outward projection 52.

Referring to FIG. 10, a fuel cell stack is constituted by a laminated body of the unit fuel cells 1 formed using the separator 50. Here, voltage monitoring is performed in units of a block 53 comprising a plurality of laminated unit fuel cells 1. Accordingly, the cathode separator of the unit fuel cell 1 on the tip end of the block 53 is rotated 180 degrees about the center O in advance. Likewise, the cathode separator of the unit fuel cell 1 on the tip end of the adjacent block 53 is rotated 180 degrees about the center O in advance. The rotated cathode separators are indicated by the reference symbol 50e.

The outward projections on the cathode separators that are not rotated 180 degrees are indicated by the reference symbols 51f and 52f. The two terminals of the voltage monitor are connected respectively to the outward projections 51e on the two rotated cathode separators 50e.

As can be understood from FIG. 9, all members of the separator 50 are formed in point symmetry about the center O apart from the outward projections 51 and 52. The form of the air passage 12, or in other words the diffusers 30 and 31, the hydrogen introduction manifold 20 and hydrogen discharge manifold 21, the cooling water introduction manifold 26 and cooling water discharge manifold 27, and the air introduction manifold 24 and air discharge manifold 25, respectively exhibit point symmetry about the center O. The air passage 12 also takes a point symmetrical form about the center O. Accordingly, even when the separator 50 is used after being rotated 180 degrees about the center O, the supply direction of the hydrogen, air, and cooling water is simply reversed, and no problems are caused. On the other hand, the outward projections 51 and 52, which are formed in positions that do not exhibit point symmetry about the center O, arrive in positions which do not overlap with the pre-rotation positions of the outward projections 52 and 51, as shown in the drawing, when the separator 50 is rotated 180 degrees about the center O. The outward projections 52f and 51f in the drawing indicate the pre-rotation positions of the outward projections 52 and 51, while the outward projection 51e indicates the position of the outward projection 51 after being rotated 180 degrees. Since FIG. 10 is a perspective view, a post-rotation outward projection 52e is not shown.

In the fuel cell stack assembled in this manner, the two terminals 91 of the voltage monitor 92 described in the first embodiment are connected to the outward projections 51e positioned on either side of the block 53. As can be determined from the drawing, the projections 51e are positioned at a sufficient remove from each other on either side of the block 53 that is to be subjected to voltage measurement. As a result, the terminals 91 do not come into contact with each other, and moreover, since the other outward projections 51f, 52f, 52e are all positioned in locations which do not overlap with the outward projections 51e in the axial direction, there is no danger of a short-circuit between the projections 51e and the other projections 51f, 52f, 52e.

In this embodiment also, short-circuits between adjacent outward projections 51f, 52f, 52e, 52f can be prevented reliably in all sites of the fuel cell stack by cutting off the outward projections 51f, 52f, 52e, 52f that are not connected to the terminals 91, or by covering these outward projections 51f, 52f, 52e, 52f with an insulating member. The outward projections 51 and 52 of the separator 50 may be formed in any positions as long as they do not overlap with other outward projections when the separator 50 is rotated 180 degrees about the center O.

In this embodiment, the outward projections 52e of a different block 53 from the block 53 whose voltage is measured by the voltage monitor 92 are connected to another monitor for monitoring a voltage or other electric output signal. This monitor is also constituted integrally with the fuel cell stack in advance, and thus forms a part of the in-service fuel cell stack.

When the fuel cell stack does not require another monitor, the outward projection 52 may be omitted from the separator 50. In this case, there is no possibility of the outward projection 51e overlapping with another outward projection after being rotated 180 degrees, and therefore the outward projection 51 may be formed in any desired position on the outer circumference of the separator 50.

In this embodiment, the monitor 92 is connected to the cathode separators which have been rotated about the center O, but it is also possible to rotate a pair of anode separators about the center O in the same way as described above with respect to the cathode separators and connect the monitor 92 to the rotated anode separators.

According to this embodiment, the anode separator 7 and cathode separator 8 may be constituted using the identically formed separator 50, and therefore the manufacturing cost of the fuel cell stack can be reduced.

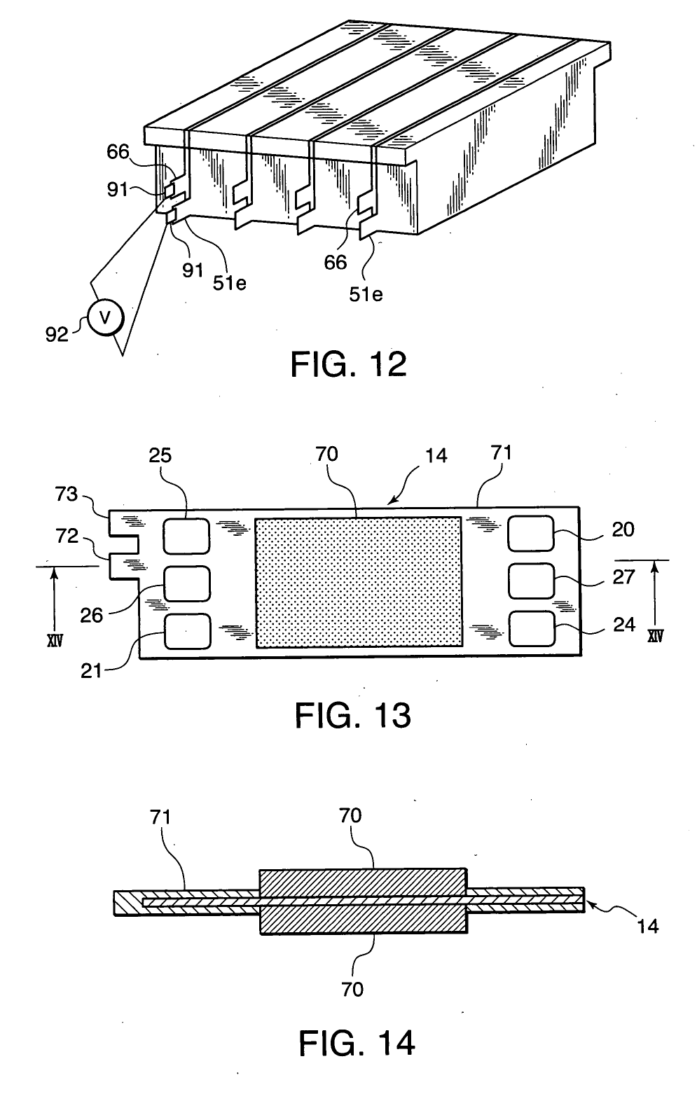

Next, referring to FIGS. 11 and 12, a third embodiment of this invention will be described.

In this embodiment, the separator 50 according to the second embodiment is applied to the cathode separator, while an anode separator 65 having a different form to that of the separator 50 according to the second embodiment is used. FIG. 11 is a front view of the anode separator 65 seen from the MEA 13 side.

In this embodiment, an outward projection 66 is formed on one short side 65b of the rectangular anode separator 65. The outward projection 66 is formed in a position which, when the separator 65 is rotated 180 degrees about the center O, does not overlap in the fuel cell lamination direction with the outward projection 51e of the rotated separator 50 shown in FIG. 10.

Referring to FIG. 12, in a fuel cell stack according to this embodiment, the anode separator 65 positioned on the opposite side of the MEA 13 to the rotated outward projection 51e is rotated 180 degrees about the center O and then laminated onto the fuel cell stack. As a result, as shown in the drawing, the outward projection 51e of the separator 50 constituting the cathode separator and the outward projection 66 of the anode separator 65 protrude sideways from the fuel cell stack in non-overlapping positions in the lamination direction of the unit fuel cell 1. The two terminals 91 of the voltage monitor 92 are connected respectively to the outward projection 51e and the outward projection 66. The voltage monitor 92 detects the generated voltage of the unit fuel cell 1 having the outward projection 51e and the outward projection 66 to which the terminals 91 are connected. The outward projection 51e and the outward projection 66 are provided in positions which do not overlap in the lamination direction of the unit fuel cell 1, and hence there is no danger of contact caused by vibration or the like. As a result, the generated voltage of the unit fuel cell 1 can be detected without fear of a short-circuit between the terminals 91.

In the drawing, a plurality of combinations of the outward projection 51e and the outward projection 66 are illustrated in relation to a single fuel cell stack, but the fuel cell stack may be formed by selecting an arbitrary unit fuel cell 1 to be subjected to generated voltage measurement in advance, rotating only the separator 50 constituting the cathode separator and the anode separator 65 of the selected unit fuel cell 1 180 degrees about the center O, and not rotating the other laminated separators. According to this embodiment, generated voltage measurement can be performed on an arbitrary unit fuel cell 1 selected in advance using the voltage monitor 92 while preventing short-circuits between the terminals 91.

In this embodiment, the generated voltage of the unit fuel cell 1 is measured, but needless to say, the outward projection 51e and the outward projection 66 may be used to measure the generated voltage of a block formed by laminating together a plurality of unit fuel cells 1, similarly to the second embodiment. The effect of preventing short-circuits between the terminals 91 can be obtained particularly favorably by applying this embodiment to a case in which the number of unit fuel cells 1 constituting a block is small, and the interval between the terminals 91 in the lamination direction is short.

Next, referring to FIGS. 13-16, a fourth embodiment of this invention will be described.

Referring to FIGS. 13 and 14, an MEA 14 according to this embodiment comprises a cover 71 covering the electrolyte membrane 2 in areas other than a power generation area 70 in which the hydrogen and the oxygen in air initiate the power generation reaction. The anode catalyst layer 3, anode gas diffusion layer 5, cathode catalyst layer 4, and cathode gas diffusion layer 6 are formed in the power generation area 70.

The cover 71 is formed from a heat-resistant, acid-resistant, steam-resistant resin.

Practically, however, any resin which has an electric insulating property and does not deteriorate in the operating environment of a fuel cell stack may be used as the material for the cover 71.

The cover 71 prevents exposure of the electrolyte membrane 2 in areas other than the power generation area 70. An acid polymer membrane is used on the anode side of the electrolyte membrane 2. The cover 71 covers the electrolyte membrane 2, and therefore functions to reinforce the electrolyte membrane 2 physically as well as to prevent chemical deterioration of the acid polymer membrane.

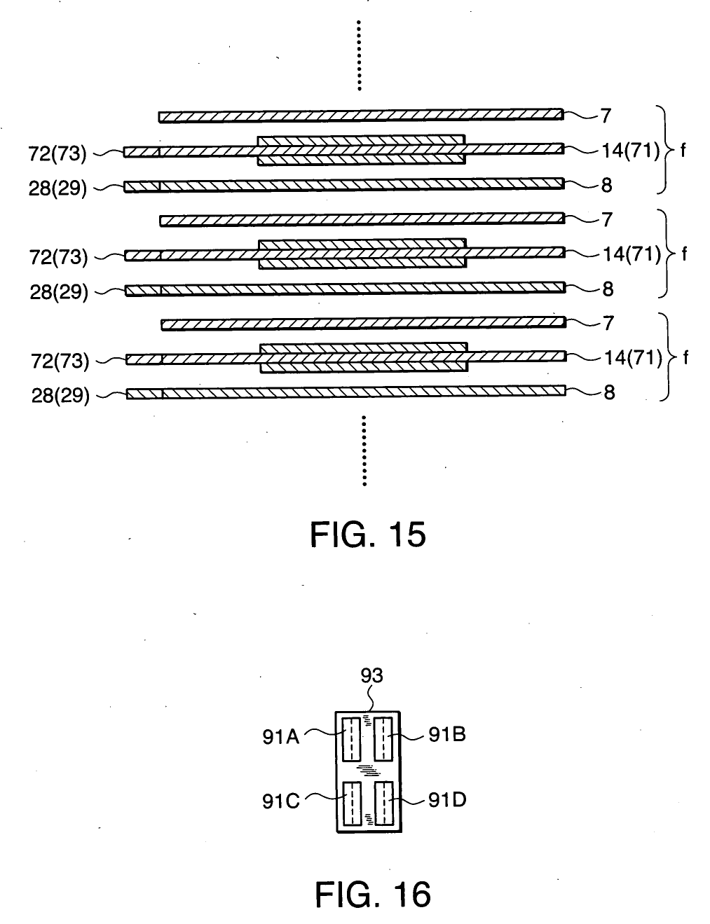

Referring to FIG. 15, the MEA 14 according to this embodiment is used in combination with the cathode separator 8 of the first embodiment shown in FIG. 3. The cathode separator 8 of the first embodiment comprises the outward projections 28 and 29. The cover 71 covering the electrolyte membrane 2 comprises outward projections 72 and 73 which overlap the outward projections 28 and 29. The outward form of the MEA 14 is identical to that of the cathode separator 8. As a result, the outward projection 28 of the cathode separator 8 and the outward projection 72 of the cover 71 overlap alternately in the lamination direction of the unit fuel cell 1, and the outward projection 29 of the cathode separator 8 and the outward projection 73 of the cover 71 also overlap alternately in the lamination direction of the unit fuel cell 1.

Referring to FIG. 16, the connector 93 connected to the outward projections 28 and 29 comprises the four insertion holes 91A-91D, similarly to the first embodiment. In this embodiment, however, the insertion holes 91A and 91B are formed in a size enabling insertion of the overlapped outward projection 29 and outward projection 73. Likewise, the insertion holes 91C and 91D are formed in a size enabling insertion of the overlapped outward projection 28 and outward projection 72.

When the unit fuel cells 1 are laminated together to form a fuel cell stack, the outward projection 72 of the cover 71 is interposed between the outward projections 28 of the cathode separators 8, and the outward projection 73 of the cover 71 is interposed between the outward projections 29 of the cathode separators 8. Hence, even when the outward projections 28 and 29 that are not connected to the connector 93 vibrate or deform, contact with the outward projections 28 and 29 on the cathode separator 8 of the adjacent unit fuel cell 1 is prevented by the outward projections 72 and 73 on the cover 71.

The outward projections 72 and 73 of the cover 71 are preferably formed larger than the outward projections 28 and 29 of the cathode separator 8. In so doing, contact between adjacent outward projections 28 or contact between adjacent outward projections 29 can be prevented even more completely.

According to this embodiment, in addition to the effects of the first embodiment, short-circuits caused by contact between adjacent outward projections 28 and short-circuits caused by contact between adjacent outward projections 29 can be fully prevented. Moreover, the electrolyte membrane 2 is physically reinforced, and deterioration thereof caused by a chemical reaction is suppressed.

The contents of Tokugan 2005-088095, with a filing date of Mar. 25, 2005 in Japan, are hereby incorporated by reference.

Although the invention has been described above by reference to certain embodiments of the invention, the invention is not limited to the embodiments described above. Modifications and variations of the embodiments described above will occur to those skilled in the art, within the scope of the claims.

The embodiments of this invention in which an exclusive property or privilege is claimed are defined as follows:

What is claimed is:

1. A fuel cell stack comprising:
membrane electrode assemblies and separators alternately laminated in a lamination direction; and
a monitor which collects data representing a power generation state of a membrane electrode assembly located between two specific separators, the monitor having two terminals which are connected respectively to the two specific separators;
wherein each of the two specific separators comprises an outward projection on an outer circumference thereof, the outward projections of the two specific separators being arranged so as not to overlap with each other in the lamination direction, and the terminals are connected to the outward projections of the two specific separators.

2. The fuel cell stack as defined in claim 1, wherein each separator comprises two outward projections on the outer circumference thereof, and the two terminals are connected to two diagonally-opposed outward projections from among the four outward projections of two adjacent separators.

3. The fuel cell stack as defined in claim 2, wherein the separator takes a rectangular planar form, and the two terminals are formed in series along one side of the rectangle.

4. The fuel cell stack as defined in claim 2, wherein the separator takes a rectangular planar form, and the two terminals are formed respectively on two adjacent sides of the rectangle.

5. The fuel cell stack as defined in claim 2, wherein the two terminals are provided in a connector formed with insertion holes into which the two diagonally-opposed outward projections are inserted, each insertion hole being connected electrically to the monitor, and insulated insertion holes into which the remaining two outward projections are inserted.

6. The fuel cell stack as defined in claim 1, wherein the membrane electrode assembly comprises an anode catalyst layer and a cathode catalyst layer on either side, the separator comprises an anode separator facing the anode catalyst layer and a cathode separator facing the cathode catalyst layer, two outward projections are formed on each of the cathode separators, and the two terminals are connected to two outward projections formed on different cathode separators so as not to overlap in the lamination direction.

7. The fuel cell stack as defined in claim 1, wherein the membrane electrode assembly comprises a resin cover covering an electrolyte membrane, the cover being formed with outward projections which overlap in the lamination direction with the outward projections formed on the separator.

8. A fuel cell stack in which membrane electrode assemblies, each having an electrolyte membrane, and separators sandwiching the membrane electrode assemblies, are laminated alternately, the fuel cell stack comprising:
a monitor which collects data representing a power generation state of a membrane electrode assembly located between two specific separators, the monitor having two terminals which are connected respectively to the two specific separators,
wherein the separator is formed in point symmetry about a diagrammatic center, the separator comprises an outward projection on an outer circumference thereof, and the two specific separators are laminated after being rotated 180 degrees about the diagrammatic center.

9. The fuel cell stack as defined in claim 8, wherein the separator comprises a plurality of the outward projections on the outer circumference thereof.

10. The fuel cell stack as defined in claim 8, wherein the membrane electrode assembly comprises an anode catalyst layer and a cathode catalyst layer on either side, the separator comprises an anode separator facing the anode catalyst layer and a cathode separator facing the cathode catalyst layer, and the two specific separators are constituted by two specific cathode separators.

11. The fuel cell stack as defined in claim 8, wherein the membrane electrode assembly comprises an anode catalyst layer and a cathode catalyst layer on either side, the separator comprises an anode separator facing the anode catalyst layer and a cathode separator facing the cathode catalyst layer, the specific separators are constituted by a specific cathode separator and a cathode separator adjacent to an anode separator, and the outward projection of the cathode separator is formed in a different position to the outward projection of the cathode separator.
